(19) United States
(12) Patent Application Publication
(10) Pub. No.: US 2005/0108351 A1
(43) Pub. Date: May 19, 2005

(54) Private email content

(75) Inventors: Indran Naick, Cedar Park, TX (US); Jeffrey Kenneth Wilson, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/713,739

(22) Filed: Nov. 13, 2003

(51) Int. Cl. G06F 15/16

(52) U.S. Cl. 709/207

(57) ABSTRACT

Methods, systems, and media for employing private email content in an email message are disclosed. Embodiments include hardware and/or software for identifying an instance of private content in an email message, associating the instance with a recipient, and generating emails for each recipient, wherein the emails are redacted to display the email message with the instance when routed to a recipient associated with the instance and to exclude the instance when routed to a recipient that is not associated with the instance. Private content may include text in the body of an email that is identified by the user as being content for less than all of the recipients. In particular, a user may compose a message that contains text, some of which includes private content, and address the email to multiple recipients. The user may then associate one or more of the recipients with each separately identified instance of the private content so that recipients see the text that the user intends them to see.

### CROSS-REFERENCES TO RELATED APPLICATIONS

Pursuant to 35 USC § 119(e), this application claims priority to and benefit of U.S. patent application Ser. No. ______, entitled “OPTIONAL RECEIPT OF AN EMAIL ATTACHMENT”, attorney docket number AUS920030776US1, filed on the same day, the disclosure of which is incorporated herein in its entirety for all purposes.

Pursuant to 35 USC § 119(e), this application claims priority to and benefit of U.S. patent application Ser. No. ______, entitled “SELECTIVE TRANSMISSION OF AN EMAIL ATTACHMENT”, attorney docket number AUS920030775US1, filed on the same day, the disclosure of which is incorporated herein in its entirety for all purposes.

### FIELD OF INVENTION

The present invention is in the field of electronic mail (email) messaging. More particularly, the present invention relates to methods, systems, and media to generate a multi-part email for multiple recipients that includes private content for one or more of the recipients.

### BACKGROUND

Electronic messaging or email is a prevalent form of communication for businesses and individuals. Emails facilitate delivery of information in the form of written text and attachments such as photos and articles. Further, with the proliferation of electronic documents such as portable digital format (PDF) files and the reduction in costs for high bandwidth connections with the Internet or within intranets via fast Ethernet, digital subscriber lines (DSLs), and cable modems, delivery of emails can be substantially concurrent with transmission, encouraging many users to choose email over “snail mail”, or physical mail delivery via, e.g., the United States Post Office, Fed EX™, and UPS™.

Users typically compose emails via email programs, also referred to as “email clients”, such as Lotus Notes™, Microsoft Outlook™, Microsoft Outlook Express™, and the like. The email programs often provide graphical user interfaces (GUIs) to compose text messages. The GUIs are similar to, but often slightly more limited than, the GUIs found in word processing applications like Lotus Notes™ and Microsoft Word™ and, in some email programs, the user can elect to compose messages in a word processing application instead of the built in GUI. In addition, users can typically search for and select recipients from an electronic address book, which is often the user's primary source of contact information for personal and/or business contacts. The address book, for example, may include information such as physical mailing addresses, phone numbers, and email addresses.

Once the user chooses a recipient and composes the email message the user can deliver the email message in the form of an email to the recipient by simply pressing a “send” button via the GUI. More specifically, the user initiates a software function in the email program that packages the email message into a standard email format, also referred to as an “envelope”, such as International Telecommunication Union-Telecommunication Standards (ITU-T) X.400 transmits the email to an email server, typically residing on a separate computer. The email server detects the recipient to which the email is addressed and generates an email header to route the e-mail, e.g., via a simple mail transfer protocol (SMTP), to email messaging middleware, such as a post office protocol three (POP3) server or an Internet message access protocol four (IMAP4) server, which stores the incoming email in a mailbox for retrieval by each recipient.

In many instances, particularly instances in which emails include information that the user wants to communicate with multiple recipients, the user can compose the e-mail, select multiple recipients, and broadcast the email to the multiple recipients by pressing the “send” button. However, the user may find that in some situations, information that the user would like to include in the email is only relevant to one of the recipients (or at least less than all of the recipients), while other information should be sent to multiple, or even all, of the recipients. In fact, some information intended for one recipient may, for other recipients, detract from the effectiveness of the communication embodied by the email.

In some of these situations, the user may find that it is convenient to address the email to all the intended recipients and point out via the text of the e-mail, which recipients should read, e.g., the general information and which recipients should read certain portions of the e-mail. For example, a user may manage a group of individuals and decide to instruct them, via an email, about the scope of a project as well as their individual roles in relation to the project. The text, or body, of the email may contain general information that describes the scope of the project to all the recipients and additional information that is directed to one or more of the recipients by introducing the information with the name of the intended recipient. The individual recipients then find the information about their individual roles by scanning the email for their names. Although the user saves time by drafting a single email message and addressing that single email message to multiple recipients, the recipients must parse through a lot of information that is not relevant to their roles in the project before reaching the information that is relevant.

Alternatively, the user may compose separate emails for each individual or group of individuals, copying and pasting the same email message for each recipient and revising the message to include only the information that is intended for the particular recipient or group of recipients. For instance, the user may copy and paste the general project information into each email message and add, to each email message, information about the roles for the specific recipient(s). This is cumbersome and leads to errors, particularly when several recipients are involved. Further, some of recipients may need information about the roles of other recipients in addition to information about their own roles. The opposite is not necessarily true. For example, a project expediter may need information that describes the expediter's role as well as roles of one or more of the individual recipients. On the other hand, the individual recipients do not need to receive the information describing the project expediter's role. As a further illustration, some information that is to be sent to less than all of the recipients may be confidential information. The confidential information should not be sent to all of the recipients, so the user is forced to perform the arduous and error-prone task of composing separate email messages for each recipient.

### SUMMARY OF THE INVENTION

The problems identified above are in large part addressed by methods, systems, and media to employ private content in an email message. One embodiment provides a method for employing private content in an email message for recipients. The method generally includes identifying an instance of the private content in the email message; associating the instance with a recipient of the recipients; and generating emails for the recipients, wherein the emails are redacted to display the email message with the instance when routed to the recipient and to exclude the instance when routed to another recipient of the recipients.

Another embodiment provides an apparatus for employing private content in an email message for recipients. The apparatus contemplates a content identifier to identify an instance of private content in the email message; a content associator to associate the instance with a first recipient of the recipients; and an email generator to redact the email message to display the email message with the instance when routed to the first recipient and to exclude the instance when routed to another recipient of the recipients.

A further embodiment provides a machine-accessible medium containing instructions, which when executed by a machine, cause said machine to perform operations. The operations can involve identifying an instance of private content in an email message composed for recipients; associating the instance with a recipient of the recipients; and generating emails for the recipients, wherein the emails are redacted to display the email message with the instance when routed to the recipient and to exclude the instance when routed to another recipient of the recipients.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an embodiment of a system including a client computer system, email servers, and recipients coupled via a LAN and/or WAN to accommodate private email content;

FIGS. 2-3 depict embodiments of dialogues to identify private content and associate recipients with the private content;

FIG. 4 depicts an embodiment of a device to accommodate private email content; and

FIG. 5 depicts an example of a flow chart to accommodate private email content via an email client.

FIGS. 6A-B depicts an embodiment of a graphical user interface (GUI) to compose an email message that identifies private email content and associates a recipient with the private content.

FIG. 7 depicts an example of a flow chart for an email server to identify private email content and associate recipients with the private content.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments, but on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, methods, systems, and media for employing private email content are contemplated. Embodiments include hardware and/or software for identifying private content in an email message, associating the private content with one or more recipients for the email message, and generating emails for all the recipients, to include instances of the private content for specified recipients. Private content may include text in the body of an email that is identified by the user as being content for less than all of the recipients. In particular, a user may compose a message that contains text, some of which includes private content, and address the email to the desired recipients. The private content may be identified, for instance, while the user is typing the text by, e.g., inserting special characters that distinguish portions of the text from other portions of the text, associating an index with private content in the email message, or after typing the text by highlighting portions of the text that include the private content. The user may then associate recipient(s) with each separately identified instance of the private content.

After recipients are associated with each instance of the private content, different emails are generated for each recipient or group of recipients associated with a distinct instance or combination of instances of the private content, advantageously allowing the user to compose a single email for all the recipients. Some embodiments generate separate emails from the email message for the recipients via an email program on the client computer system. Other embodiments incorporate functionality into an email server that allows the email server to detect instances of private content associated with specified recipients and general content associated with all of the recipients. The email server can then route versions of the email message to the recipients, redacting emails to exclude instances of the private content from emails for unintended recipients.

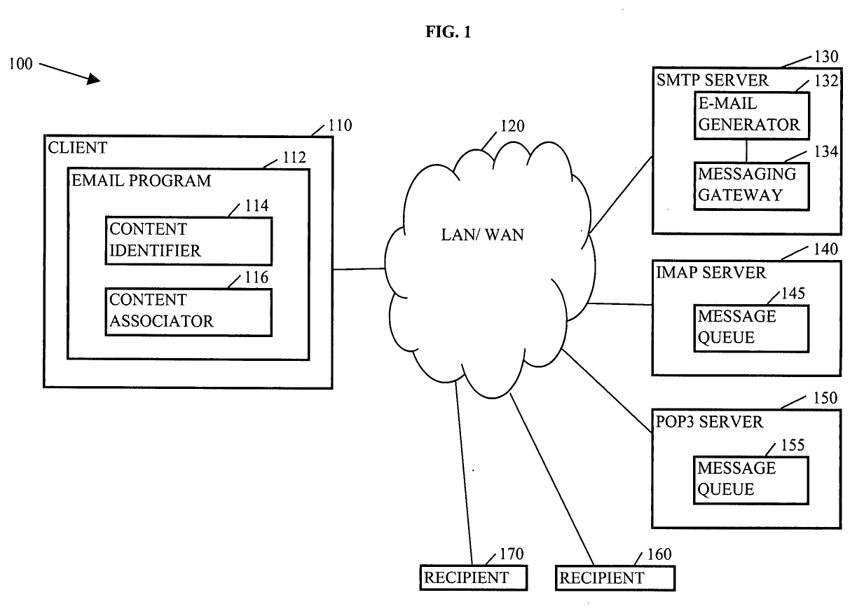

Turning now to the drawings, FIG. 1 depicts an embodiment of a system 100 to employ private email content. More specifically, system 100 may include a client 110 having email program 112 to facilitate composition of an email message with private content and to distribute the email message to recipients 160 and 170 based upon associations between the recipients and the private content. For example, a user may compose an email message for recipients 160 and 170 via email program 112, indicating that one or more instances of private content are to be sent to recipient 160. Email program 112, such as Lotus Notes™, may then insert data, such as an index, into the header of email to identify instances of the private content and that recipient 160 is associated with each instance of the private content. When email program 112 transmits the email to simple mail transfer protocol (SMTP) server 130, email generator 132 may redact the email for recipient 170 to exclude the instances of the private content and include the instances of private content in an email designated for recipient 160. Messaging gateway 134 may then route the corresponding emails to recipients 160 and 170 via a local area/ wide area network (LAN/ WAN) 120.

System 100 includes client 110, LAN/ WAN 120, SMTP server 130, an Internet message access protocol (IMAP) server 140, a post office protocol (POP) server 150, and recipients 160 and 170. Client 110 may include any microprocessor-based device such as a laptop computer, a desktop computer, a personal digital assistant (PDA), a cellular phone, and the like, that have capabilities of executing an email program or composer and accessing an email server such as SMTP server 130, IMAP server 140, and/or POP server 150 via an intranet or the Internet. For example, a user may have a PDA that includes an email program 112 such as a limited version of Microsoft Outlook™. The email program 112 may include a composer that facilitates composing an email message and addressing the email message to one or more recipients. When the email message is addressed to more than one recipient, the email program 112 may display a dialogue box that prompts the user to identify a portion of the email message as private content. A content identifier 114 may then provide tools to the user to identify portions of the composed message as private content and a content associator 116 may provide tools for the user to associate recipients of the email message with one or more instances of the private content.

Content identifier 114 may offer the user one or more options for selecting private content. More specifically, content identifier 114 may identify text as an instance of private content by highlighting the text or clicking on the text with a mouse or similar device. For example, after the user indicates the inclusion of private content in a message, the user points to the start and/or end of an instance of the private content and clicks a mouse button or presses a key. In response, content identifier 114 may add one or more special characters or marks to the text of the message to identify the start and/or end of an instance of the private content. In further embodiments, content identifier 114 may add an index or lookup table to the message such as data in the header or footer to indicate the location(s) of instances of private content.

In other embodiments, content identifier 114 may search the text of the message composed by the user to locate special characters or marks that demarcate the start and/or the end of an instance of private content. For example, while the user is composing the message, the user may insert a special character before and after the private content to indicate that the private content should be excluded from at least one of the email messages routed to the at least one of the recipients.

Content associator 116 may offer the user one or more options for selecting recipients to associate with the private content. For instance, after identifying an instance of the private content, content associator 116 may display a dialogue including the current recipients for the email message. The user may then select one or more recipients from the list and, in some embodiments, add recipients to the list via, e.g., an address book. More specifically, the dialogue may list each recipient of the message with a check box next to each and the user may select the recipient(s) for the private content by checking boxes next to the recipients or press a button to associate recipients that are not listed.

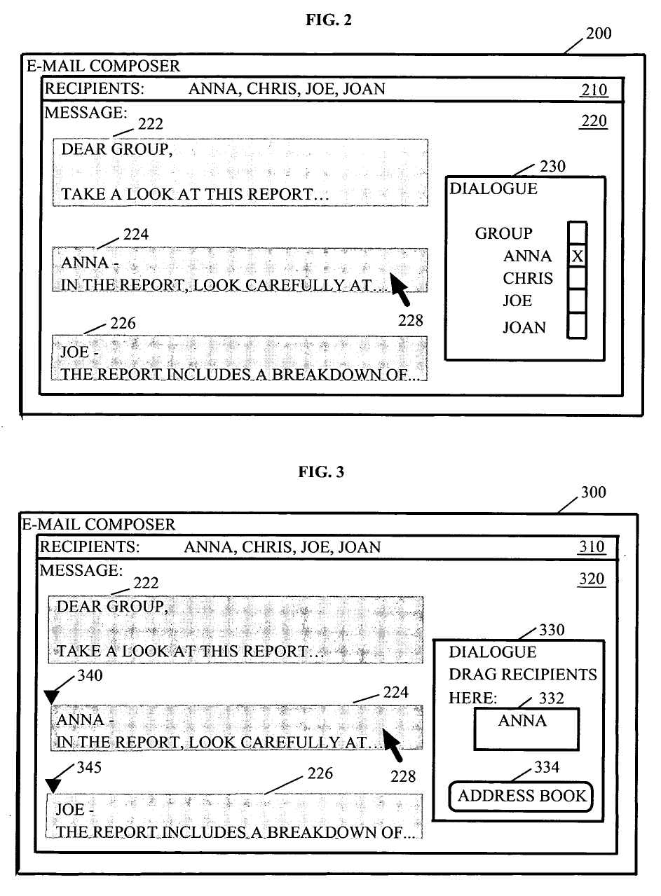

FIGS. 2 and 3 illustrate examples of screen shots 200 and 300 for implementations of an email program 112 including private content identifier 114 and content associator 116. In FIG. 2, the user has composed a message 220 including a portion of text 222 intended for all the recipients of group 210, a portion of text 224 intended for “Anna”, who is a recipient of group 210, and a portion of text 226 intended for “Joe”, who is also a recipient of group 210. Group 210 may include recipients in any category of the email header such as “TO” recipients, “CC” recipients, and/or “BCC” recipients. In this illustration, content identifier 114 highlights text separated by carriage returns and allows the user to right click on the portion of text 224 that is intended to be an instance of private content for “Anna”. In response to pointing cursor 228 at text 224 and pressing the right mouse button, content associator 116 displays a dialogue 230 including all the recipients currently associated with the message 220. Dialogue 230 provides lists the recipients as selected by the user, group 210, and since group 210 represents multiple recipients, dialogue 230 also lists each recipient in group 210 next to a check box. The user may then associate “Anna” with text 224 by marking the check box next to “Anna” in dialogue 230. In further embodiments, content associator 116 may provide for menu driven selection of recipients to associate with private content.

In FIG. 3, the user has composed the message 320 and addressed the message to recipients Anna, Chris, Joe, and Joan in email header 310. While composing the message or after composing the message, content identifier 114 facilitates marking the portions of text 224 and 226 with characters 340 and 345 to indicate that those portions of the text 224 and 226 are instances of private content. Content associator 116 may then provide a dialogue 330 for selecting the recipients such as allowing the user to look up recipients in an address book 334 or to drag a recipient from email header 310 to dialogue 330 and/or to the portion of text 224 and/or 226. Other methods for associating the portion of text 224 with a recipient are also contemplated.

Referring again to FIG. 1, after one or more portions of the text in the message composed by the user are identified as private content and associated with recipients, the email message is transmitted to an email server such as SMTP server 130 via LAN/WAN 120. LAN/WAN 120 is a network connection to couple client 110 with servers such as SMTP server 130, IMAP server 140, POP server 150, and recipients 160 and 170 to transmit email messages between the computers. In some embodiments, LAN/WAN 120 may include a network in an office coupled via Ethernet, optical media like OptiConnect, or the like. In several embodiments, LAN/WAN 120 also couples with the Internet via a cable modem, a direct subscriber line (DSL), a T1 line, a T3 line, or the like. In further embodiments, LAN/WAN 120 may include a network of temporary connections such as connections via a telephone system.

SMTP server 130 may receive the email message from a user, generate emails for each recipient, and route the emails to the recipients. More specifically, SMTP server 130 includes email generator 132 to generate emails for each recipient of a message based upon identified private content and recipients associated with the private content. For instance, email generator 332 may receive an email message from a user including data in a header, footer, or in the body of the message that indicates less than all of the recipients are to receive the private content. Email generator 332 may then generate emails for each recipient, excluding private content that is not associated with the corresponding recipients. In some embodiments, when the message is to be delivered in hypertext markup language (HTML) format, HTML code is included in the emails to prevent the corresponding private content from being displayed to recipients that are not associated with the private content. In further embodiments, copies of the email message may be generated for each recipient and the copies are redacted to remove private content that is not associated with a recipient. For example, text of a message that is not identified as private content may be included in each email generated, whereas, text identified as private content may only be included in emails generated for recipients associated with the private content.

SMTP server 130 may then route the generated emails to the recipients 160 and 170 via IMAP server 140 and POP server 150, respectively. More specifically, IMAP server 140 may provide email service to recipient 160 and POP server 150 may provide email service to recipient 170. IMAP server 140 may receive the email for recipient 160 and store the email in a mailbox fir recipient 160, message queue 145. Message queue 145 may be, e.g., a hard drive that stores the email until recipient 160 removes the email from message queue 145. Recipient 160 may communicate with LAN/WAN 120 to access IMAP server 140, review email subjects to decide which emails should be downloaded, and download and/or delete the email from IMAP server 140. Similarly, POP server 150 may receive the email for recipient 170, and store the email in message queue 155. When recipient 170 logs into POP server 150, POP server 150 may begin transmitting the email to recipient 170.

Recipients 160 and 170 may include computer systems similar to client 110 having email readers adapted to retrieve emails from servers 140 and 150, and to display the emails to a user. In many embodiments, users may select and adapt any computer system having an email reader or other email program to be recipients 160 and 170.

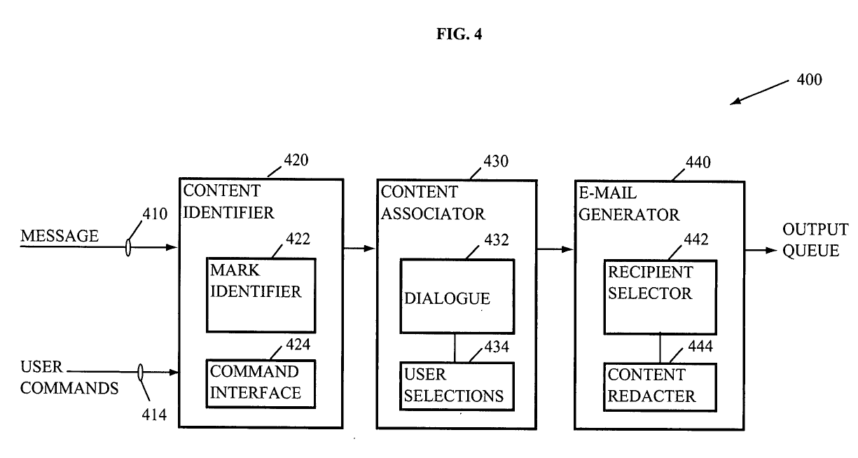

FIG. 4 depicts an embodiment of a device 400 to employ private email content in email messages. Device 400 may be integrated with an email program and/or software on an email server. Device 400 includes hardware and software adapted to interact with a user to compose a single email message to generate multiple emails that include different content depending upon the recipient to which the email is routed. For example, device 400 may include functionality implemented via a pull-down menu, a command button, a pop-up menu responsive to a mouse button, or the like, that allows a user to identify an instance of private content in an email message during and/or after the email message is composed and to associate the instance with one or more recipient(s). The user is typically given the option to associate a single instance of private content with one or more of the recipients designated in the email header.

Device 400 may include a content identifier 420, a content associator 430, and an email generator 440. Content identifier 420 may receive a message 410 and identify one or more portions of the message as private content based upon input from the user. In particular, the user may integrate one or more characters or commands into the text of message 410 while composing the message and, when device 400 is integrated with an email server, for instance, integrate an association between the private content and one or more recipients. In further embodiments, the user may interact with content identifier 420 to identify private content in message 410.

Content identifier 420 may include mark identifier 422 and/or command interface 424. Mark identifier 422 may parse message 410 to identify instances of private content. In some embodiments, mark identifier 422 may search text for characters indicative of private content. In further embodiments, mark identifier 422 may recognize one or more typical formats for messages that include private content and identify the private content based upon the formatting. For example, when device 400 is integrated with an email server, message 410 may include a table that describes locations of private content within message 410. More specifically, the table may include data such as line numbers defining locations of private text in message 410, special characters that demarcate the beginning and end of the private content, and the like.

Command interface 424 is configured to interpret user commands 414 to identify private content. For example, the user may compose message 410 and then invoke content identifier 420 to identify private content. Command interface 424 may, for instance, highlight each section of text separated by carriage returns or highlight each paragraph. Then, command interface 424 may facilitate selection of one or more highlighted sections of text as private content and generate an index or lookup table that describes the private content and associate with the index or lookup table with the message 410.

After private content is identified, each instance of private content is associated with a recipient via content associator 430. Content associator 430 may be invoked after all instances of private content are identified or as each instance of private content is identified. For example, when device 400 is partially integrated with an email program, the user may select a highlighted section of text in message 410 via command interface 424 and, in response, content associator 430 may request that the user select or identify a recipient for the private content. More specifically, content associator 430 may implement a dialogue 432 to associate recipients with private content and record the associated recipients via user selections 434.

Dialogue 432 may include one or more dialogue formats and, in some embodiments, dialogue 432 may be adaptable by user preferences. FIGS. 2 and 3 are illustrative a two different dialogue formats but other dialogue formats that interact with the user to associate one or more recipients with an instance of private content are contemplated. For example, after the user identifies an instance of private content, dialogue 432 may be available in the form of a pull-down menu. The pull-down menu may identify an instance of private content by one or more means and include a list of recipients for each instance. If the user has defined default selections for recipients, such as recipients in the “TO” field of the email header or specific recipients that the user typically communicates with, the default recipients may be pre-selected. The user can then select and/or deselect recipients, associating the recipients that remain selected with the instance of private content. In some embodiments, after dialogue 432 is activated, the first identified instance of private content in the email message may be highlighted, the user may associate recipients with the highlighted instance, and then the remaining instances of private content may be highlighted in order, allowing each of the remaining instances of private content to be associated with recipients. In further embodiments, dialogue 432 may depict a thumbnail for the email message with the highlighted instance of private content. Instances of private content may also be identified in the pull-down menu so the user may simply select the instance of private content to modify current associations between recipients and each instance of private content.

After the user associates a recipient with an instance of private content, the association may be stored via user selections 434. In some embodiments, user selections 432 stores recipient associations with each corresponding instance of private content in the email message or in a pre-determined location such as within the email header. In other embodiments, such as embodiments in which email generator 440 is part of the email program, user selections 434 may store the associations in memory or in a temporary file. For example, the user may select a paragraph containing private content for Joe. Then, the user selects Joe's email address from one of the recipient fields for the email message or from an address book and drags Joe's email address to the instance of private content for Joe. Content associator 430 interprets the users actions to associate Joe with the instance of private content and user selections 434 stores the association in a buffer that is accessible by email generator 440.

Email generator 440 may generate emails for each recipient of the message or groups of recipients of the message based upon the user's association between private content and the recipients. In particular, recipient selector 442 may review the associations between private content and recipients, select text from the email message for each recipient or group of recipients based upon identification of instances of private content and the recipients associated therewith, and then generate emails for the recipients including the selected text. In some embodiments, recipient selector 442 selects each recipient in order and generates an email for that recipient. In further embodiments, recipient selector 442 identifies groups of recipients that may receive the same or substantially similar email messages and then begins to generate emails for those recipients. For example, the user may compose a general message for all recipients, a detailed message for a sub-group of the recipients, and specific messages for individual recipients that are part of the sub-group. Recipient selector 442 may identify the recipients that receive the general message only. Email generator 440 may generate emails for those recipients with just the general message. Then, recipient selector 442 may identify the sub-group of the recipients that are only designated to receive the general message and the detailed message. Email generator 440 may then select the text of the detailed message and add it to the text of the general message to generate the corresponding emails. Finally, recipient selector 442 instructs email generator 440 to generate separate emails for each recipient associated with a distinct message and email generator 440 separately combines the text of each specific message with the text of the general and detailed messages to generate emails for the remaining recipients.

In further embodiments, email generator 440 may include a content redactor 444. Content redactor 444 may redact versions of the email message to exclude instances of private content based upon associations between the recipients and the instances of private content. In many embodiments, when the emails are to be transmitted to recipients in an HTML format, content redactor 444 may generate HTML code to insert in the messages to redact instances of private content from an email based upon the recipient to which the email is routed. For example, email generator 440 may generate an email including the entire email message composed by a user. The email message may include private content for Joe and general content associated with Joe and the remainder of the recipients. Content redactor 444 may then insert HTML code that allows the private content for Joe to be visible only in the email routed to Joe but not in the emails routed to the remainder of the recipients. Thus, when Joe receives the e-mail, the entire message is visible. When the remainder of the recipients receive the e-mail, the code inserted by content redactor 444 displays the general message but does not display the private content for Joe.

On the other hand, in several embodiments, content redactor 444 may remove private content for Joe from emails that are not being routed to Joe. For instance, the private content associated with Joe may be designated as confidential or “for Joe's eyes only”. In response to such categorization by the user, content redactor 444 may remove the private content for Joe from emails to recipients other than Joe.

Once email messages are prepared for each recipient, email generator 440 may format the messages and recipients into a standard email format and route the emails to the recipients via an outgoing email message queue, or output queue. The emails may then be packetized for transmission across a network, transmitted to another server, reassembled by the other server, and stored in mailboxes for the corresponding recipients. For instance, the output queue may store emails in order of receipt and transmit the emails as bandwidth becomes available.

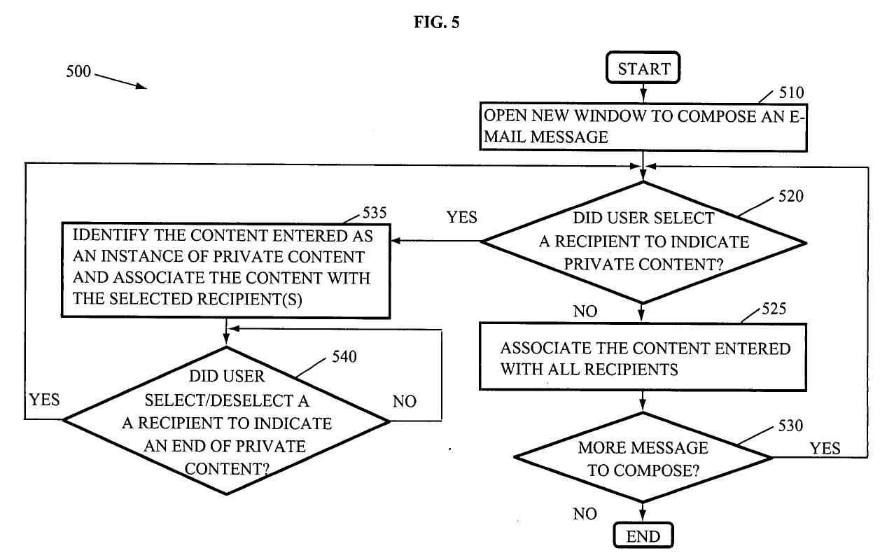

Referring now to FIG. 5, there is shown an example of a flow chart 500 for employing private content. Flow chart 500 begins with a message from a user (element 510). In particular, the user may initiate an email program such as Lotus Notes™ and request a new window to compose an email message.

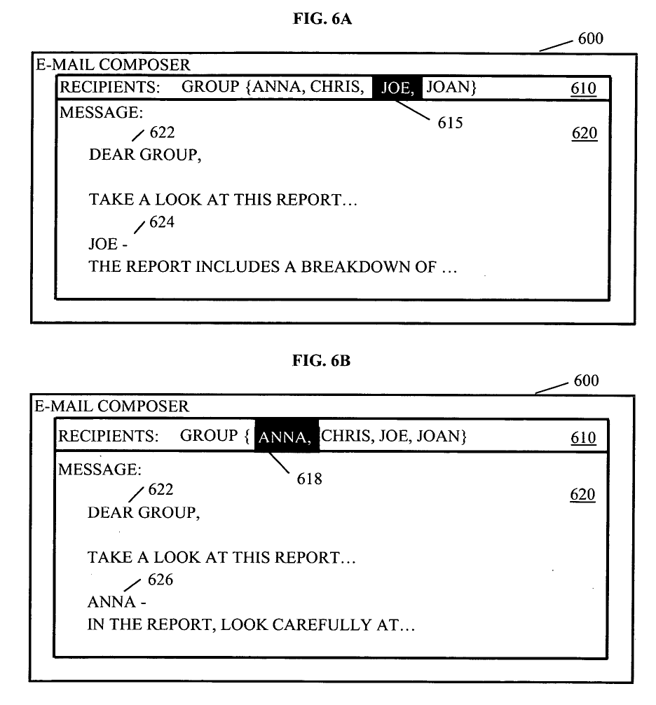

Upon opening a new message window and selecting recipients, the user may issue a command to identify private content. In several embodiments, the user may operate a pull-down menu and select a command to begin a private content dialogue. The dialogue may allow the user to enter an instance of private content and then select one or more recipients to associate with the private content, or vice versa. In one embodiment, illustrated in FIGS. 6A and 6B, the user may select less than all of the recipients to identify private content (element 520). For instance, FIGS. 6A and 6B depict an email message composer window 600 including email header 610 associating recipients represented by “Group” with a message in message window 620. “Group” represents recipients including Anna, Chris, Joe, and Joan.

Starting with FIG. 6A, the user may type a general message 622 in message window 620 for all the recipients of the email without selecting a particular recipient (element 525) from email header 610. Then, when the user wants to draft a portion of the message specifically directed toward “Joe” 615, the user may click on “Joe” 615 to indicate that an instance of private content (element 520) is about to be typed in for the recipient address represented by “Joe” 615. Indications may then be stored in the email message to identify an instance of private content associated “Joe” 615 (element 535). The indications may be stored in the email message itself or, if the email message is going to be routed to an email server to generate separate emails for “Joe” 615 and other recipients, the indications may be stored in a packet that is to accompany the e-mail. Then, the user types text 624 as the instance of private content for “Joe” 615.

Continuing forward to FIG. 6B, the user, upon composing an instance of private content 624 for “Joe”, may point a cursor at “Anna” 618 and press a mouse button, deselecting “Joe” 615 (element 540) while selecting the recipient (element 520) represented by “Anna” 618. The content identifier may interpret the action as terminating the instance of private content 624 for “Joe” 615 and initiating an instance of private content 626 to associate with “Anna” 618.

After selecting “Anna” 618, the user types the instance of private content 626 for “Anna” 618 (element 535). In some embodiments, the user may hold down a key such as a shift key or a control key while: “Joe” 615 is still selected and while selecting “Anna” 618 (element 540) to initiate an instance of private content (element 520) for both “Joe” 615 and “Anna” 618.

Note that, in FIGS. 6A and 6B, when the user deselects “Joe” 615 and selects “Anna” 618, the dialogue removes the instance of private content for “Joe” 615 from the message window 620 but continues to display the general content 622. In the present embodiment, the dialogue displays the content of the message associated with the selected recipient(s) so the user can preview the resulting message for the recipient(s). When, no recipients are selected, for instance, only the general content 622 will be displayed.

After the user composes the email message (element 530), identifies private content, and associates the corresponding instances of private content with both “Joe” 615 and “Anna” 618, the dialogue offers the user the option to preview the content for each recipient. By selecting a recipient in the email header 610, the user can preview the resulting content in an email message for that recipient. For example, if the user selects “Group” from email header 610, the message window 620 may only display the portion(s) of the message that will be forwarded to all the recipients that are represented by “Group”. The email message may be routed to an email server to generate and route emails to each recipient based upon the identification of private content and the associated recipient(s).

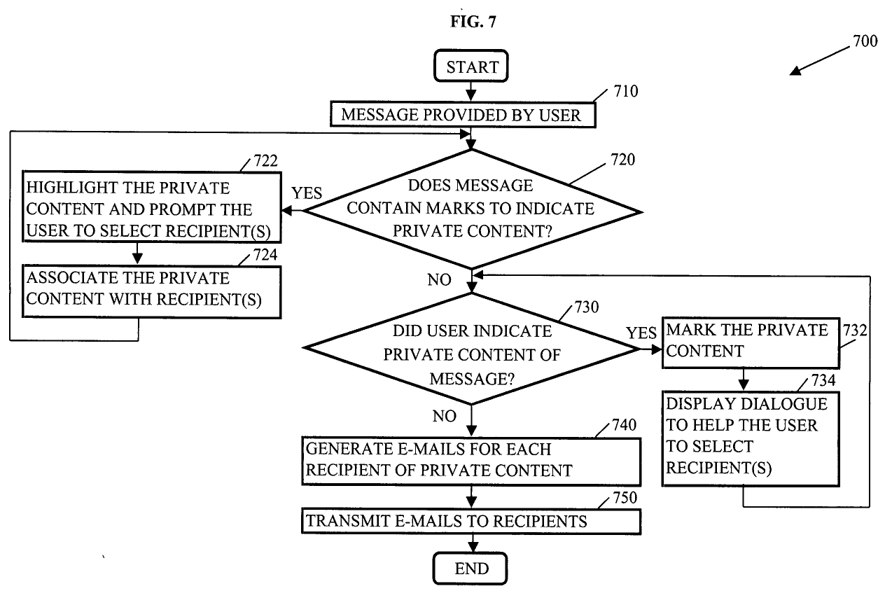

Referring now to FIG. 7, there is shown an example of a flow chart 700 for employing private content. Flow chart 700 begins upon receipt of a message from a user that includes multiple recipients (element 710). In particular, the user may compose the message with or without marks to identify instances of private content. Then, flow chart 700 is adapted to identify instances of the private content and associate the instances with recipients.

Upon receipt of the message (element 710), the message may be parsed to find marks that identify instances of private content. When the message includes marks to identify one or more instances of private content (element 720), an instance of private content may be highlighted and the user may be prompted to select one or more recipients from a list of recipients that are associated with the email message. After selecting one or more recipients, the recipients are associated with the private content by storing an association directly in the email message, storing the association in a packet to accompany the email message, or storing the association in a buffer that is accessible by software designed to generate distinct emails for the recipients of private content.

When the email message does not contain marks such as special characters or commands within the message to identify private content (element 720), the user may indicate that private content is included in the message by selecting an option, implementing a function or dialogue, or the like. In several embodiments, when multiple recipients are selected for an email, a default function may be implemented to prompt the user regarding the inclusion of private content. If the user indicates the inclusion of private content (element 730), the user may be prompted to select each distinct instance of private content by, e.g., pointing the cursor at an instance of private content and pressing one or more keys and/or a mouse button, highlighting the text of the private content, or the like. The one or more instances of private content can then be identified by inserting marks into the email message or creating an index of associations (element 732) and associating the index with the email message.

After identifying one or more instances of private content, a dialogue may be implemented to interact with the user to associate one or more recipients with each instance of the private content (element 734). Emails can be generated for each recipient including general email content and each instance of private content associated with the corresponding recipient (element 740). Then, as the emails are generated, the emails may be transmitted to the corresponding recipients (element 750).

One embodiment of the invention is implemented as a program product for use with a computer system such as, for example, the system 100 shown in FIG. 1. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods, systems, and media to employ private content in an email message. It is understood that the form of the invention shown and described in the detailed description and the drawings are to be taken merely as examples. It is intended that the following claims be interpreted broadly to embrace all the variations of the example embodiments disclosed.

1. A method for employing private content in an email message for recipients, the method comprising:
identifying an instance of the private content in the email message;
associating the instance with a recipient of the recipients; and
generating emails for the recipients, wherein the emails are redacted to display the email message with the instance when routed to the recipient and to exclude the instance when routed to another recipient of the recipients.

2. The method of claim 1, further comprising transmitting the emails to the recipients.

3. The method of claim 1, wherein identifying the instance comprises identifying a mark adjacent to the instance, wherein the mark is indicative of a bounding edge of the instance.

4. The method of claim 1, wherein identifying the instance comprises identifying the instance as a highlighted portion of text in response to a command from a user.

5. The method of claim 1, wherein associating the instance comprises interacting with a user to associate the recipient with the instance.

6. The method of claim 5, wherein interacting with the user comprises prompting the user to select the recipient from the recipients.

7. The method of claim 5, wherein interacting with the user comprises prompting the user to select the recipient from an address book.

8. The method of claim 1, wherein generating emails comprises generating an email having hypertext markup language code that is configured to display the instance in response to routing the email to the recipient.

9. The method of claim 1, wherein generating emails comprises removing the instance from the email message.

10. An apparatus for employing private content in an email message for recipients, the apparatus comprising:
a content identifier to identify an instance of private content in the email message;
a content associator to associate the instance with a first recipient of the recipients; and
an email generator to redact the email message to display the email message with the instance when routed to the first recipient and to exclude the instance when routed to another recipient of the recipients.

10. The apparatus of claim 9, further comprising a messaging gateway to transmit the first email to the first recipient.

11. The apparatus of claim 9, wherein the content identifier comprises a mark identifier to search the email message for a mark, the mark being indicative of a boundary of the instance.

12. The apparatus of claim 9, wherein the content identifier is configured to parse a table, wherein the table identifies a location of the instance in the email message.

13. The apparatus of claim 9, wherein the content associator comprises a dialogue to interact with a user to associate the first recipient with the instance.

14. The apparatus of claim 9, wherein the content associator is configured to generate an index associating the first recipient with a location of an instance in the email message.

15. The apparatus of claim 9, wherein the email generator comprises a content redactor to generate hypertext markup language code that is configured to display the instance in response to routing the email to the first recipient.

16. The apparatus of claim 9, wherein the content redactor is configured to remove the instance from text of the emails unless the email is routed to the first recipient.

17. A machine-accessible medium containing instructions, which when executed by a machine, cause said machine to perform operations, comprising:
identifying an instance of private content in an email message composed for recipients;
associating the instance with a recipient of the recipients; and
generating emails for the recipients, wherein the emails are redacted to display the email message with the instance when routed to the recipient and to exclude the instance when routed to another recipient of the recipients.

18. The machine-accessible medium of claim 17, wherein the operations further comprise transmitting the emails to the recipients.

19. The machine-accessible medium of claim 17, wherein identifying the instance comprises identifying a mark adjacent to the instance, wherein the mark is incorporated into the email message by a user and is indicative of a bounding edge of the instance.

20. The machine-accessible medium of claim 17, wherein identifying the instance comprises identifying the instance as a selection of text in response to a concurrent command from a user.

21. The machine-accessible medium of claim 17, wherein associating the instance comprises interacting with a user to associate the recipient with the instance.

22. The machine-accessible medium of claim 17, wherein generating emails comprises generating an email having hypertext markup language code that is configured to display the instance in response to routing the email to the recipient.
